(19) United States
(12) Patent Application Publication
(10) Pub. No.: US 2015/0092818 A1
(43) Pub. Date: Apr. 2, 2015

(54) Apparatus and Method for Monitoring a Reactor Surface

(71) Applicant: LIOS Technology GmbH, Koeln (DE)

(72) Inventors: Wieland HILL, Odenthal (DE); Jochen KUEBLER, Koeln (DE)

(21) Appl. No.: 14/499,923

(22) Filed: Sep. 29, 2014

(30) Foreign Application Priority Data
Oct. 1, 2013 (DE) 102013110859.8

(51) Int. Cl. G01K 11/32; G01B 11/16

(52) U.S. Cl. CPC G01K 11/32; G01B 11/16
USPC 374/161

(57) ABSTRACT

Apparatus for monitoring a reactor surface with a sensor cable, which is during operation at least partially arranged in the region of the reactor surface, has at least two optical fibers (1, 2) arranged in the sensor cable, has at least one laser light source whose light is coupled at least partially into the optical fibers (1, 2) during the operation of the apparatus, and evaluation means, in which portions of the light coupled out of the optical fibers (1, 2) are evaluated during the operation of the apparatus, for monitoring at least partially the reactor surface with respect to at least one physical size in a spatially resolved manner. The apparatus includes magnetic retaining means (8) for attaching the sensor cable (10) on the reactor surface.

### BACKGROUND OF THE INVENTION

(1) Field of the Invention

The present invention relates to an apparatus for monitoring a reactor surface in accordance with the preamble of claim 1. The present invention further relates to a method for monitoring a reactor surface.

Definitions: The terms light, optical radiation or optical signal used below refer to electromagnetic radiation in the optical spectral range, in particular from EUV to FIR. Accordingly, in the context of this application, an optical waveguide or an optical fiber will serve as a transmission medium for electromagnetic radiation in the optical spectral range.

Industrial reactors have sometimes large, irregularly shaped surfaces, which should be monitored, for example, with respect to temperature or strain. Point sensors appear unsuitable because of the large quantities needed for surface monitoring and the associated high installation and networking costs. Fiber optic systems for distributed measurement of the quantities of interest, such as DTS (Distributed Temperature Sensing) systems are able to measure a large number of measurement points along a glass fiber or a fiber optic sensor cable and are well suited to monitor surfaces when the sensor cable is installed on the surface, for example, in a spiral or meander pattern.

(2) Description of Related Art

An apparatus and a method of the aforementioned type are known from US2005/0115204 A1. In this case, external reference coils and a double-ended measurement mode are used. Monitoring the reactor is usually a safety-related task, making a high reliability mandatory. Although the double-ended measurement mode has already been proposed in the US 2006/0115204 A1 in order to increase the reliability, however, this is not adequate for continually monitoring the entire reactor surface when a fiber break occurs, because disturbances occur in the vicinity of the break point, which prevent a perfect measurement, In addition, no provision is made for the failure of the evaluation unit.

The sensor cable must also be suitably attached to the reactor surface. The conventional mounting systems are not always suitable, for example because the thermal expansion coefficients of the reactor materials and the materials used for the mounting are different. Furthermore, the mounting materials are often not permanently stable under harsh environmental conditions such as high temperature or humidity. Moreover, bolts or other fasteners may not be available on the reactor or it may be impossible to attach such elements, for example because the drilling or welding on certified pressure vessels is prohibited Furthermore, many fastening systems are not suitable for producing a thermal contact between the sensor cable and the reactor surface, which is the case, for example, with clamping devices used on irregular, in particular concave, surfaces. The installation of the sensor cable with known fastening systems is often too complex.

### BRIEF SUMMARY OF THE INVENTION

The object underlying the present invention is to provide an apparatus of the aforementioned type, which simplifies attachment of the sensor cable on the reactor surface or even allows attachment under adverse conditions. Furthermore, a method of the aforementioned type is to be provided, which offers higher reliability when an evaluation unit fails and/or an optical fiber breaks.

This is achieved according to the invention with an apparatus of the aforementioned type having the characterizing features of claim 1 and by a method of the aforementioned type having the characterizing features of claim 12. The dependent claims relate to preferred embodiments of the invention.

According to claim 1, the apparatus includes magnetic retaining means for the attachment of the at least one sensor cable on the reactor surface. For example, the retaining means may hereby have on their side that faces the reactor surface during the operation of the apparatus a slot for receiving the at least one sensor cable. The sensor cable can then be very easily secured on the reactor wall by placing the magnetic retaining means, thus making good thermal contact.

The apparatus may also include at least two optical fibers. By using two optical fibers, the device offers high reliability in the event that an optical fiber breaks.

in a particularly advantageous embodiment, the evaluation means may include at least two evaluation units, wherein each of the evaluation units is connected to a respective one of the optical fibers for evaluating the light coupled out from this optical fiber. The device is then fully redundant and also provides high reliability in the event that one evaluation unit fails.

Furthermore, the at least two optical fibers may be arranged in the same sensor cable. This ensures that the two optical fibers are arranged in close proximity to each other and that therefore, when one of the two optical fibers fails, the other optical fiber provides comparable measurement values.

Furthermore, each of the optical fibers may be connected on both sides with the evaluation means and/or the at least one laser light source. The combination of two optical fibers and a double-ended measurement provides the advantage for monitoring the temperature of high-temperature systems that the entire system can still be monitored in the event of a fiber break. Moreover, an automatic recalibration of the temperature measurement may be performed when a fiber ages, for example, when the differential attenuation of the wavelength(s) of the laser light used for the measurement increases under the influence of high temperatures.

Furthermore, the apparatus may include control means, wherein each of the evaluation units is connected to the control means. The control means may in particular monitor the operation of the evaluation units and thus ensure that a failure of an evaluation unit is reliably detected.

The apparatus may include mat-shaped or mesh-shaped retaining means for attaching the at least one sensor cable on the reactor surface. For example. the at least one sensor cable may be connected to the retaining means. Preferably, the mat-shaped or mesh-shaped retaining means are disposed so as to at least partially surround the surface of the reactor during the operation of the apparatus. Such a configuration of the retaining means is particularly suitable for systems having convex surfaces.

According to claim 12, the method for monitoring a reactor surface is characterized by the following method steps:
at least one sensor cable having at least two optical fibers is at least partially arranged in the region of the reactor surface;
laser light is coupled into the optical fibers;
portions of the light coupled out of the optical fibers are evaluated to monitor at least parts of the reactor surface with respect to at least one physical quantity in a spatially resolved manner.

The portions of the light coupled out of the at least two optical fibers may be evaluated independently, especially in different evaluation units. In particular the operation of the evaluation units may also be monitored.

### BRIEF DESCRIPTION OF THE SEVERAL VIEWS OF THE DRAWING(S)

The invention is described in more detail with reference to the accompanying drawings, which show in:

FIG. 1 a schematic view of an apparatus according to the invention;

FIG. 2 a schematic side view of a first embodiment of magnetic retaining means of an apparatus according to the invention;

FIG. 3 a bottom view of the magnetic retaining means of FIG. 2;

FIG. 4 a schematic side view of a second embodiment of magnetic retaining means of an apparatus according to the invention;

FIG. 5 a bottom view of the magnetic retaining means of FIG. 4;

FIG. 6 a schematic side view of a first embodiment of mat-shaped or mesh-shaped retaining means of an apparatus according to the invention;

FIG. 7 a schematic perspective view of a part of reactor with the retaining means of FIG. 6;

FIG. 8 a schematic side view of a second embodiment of mat-shaped or mesh-shaped retaining means of an apparatus according to the invention.

### DETAILED DESCRIPTION OF THE INVENTION

Identical or functionally identical components have identical reference symbols in the figures.

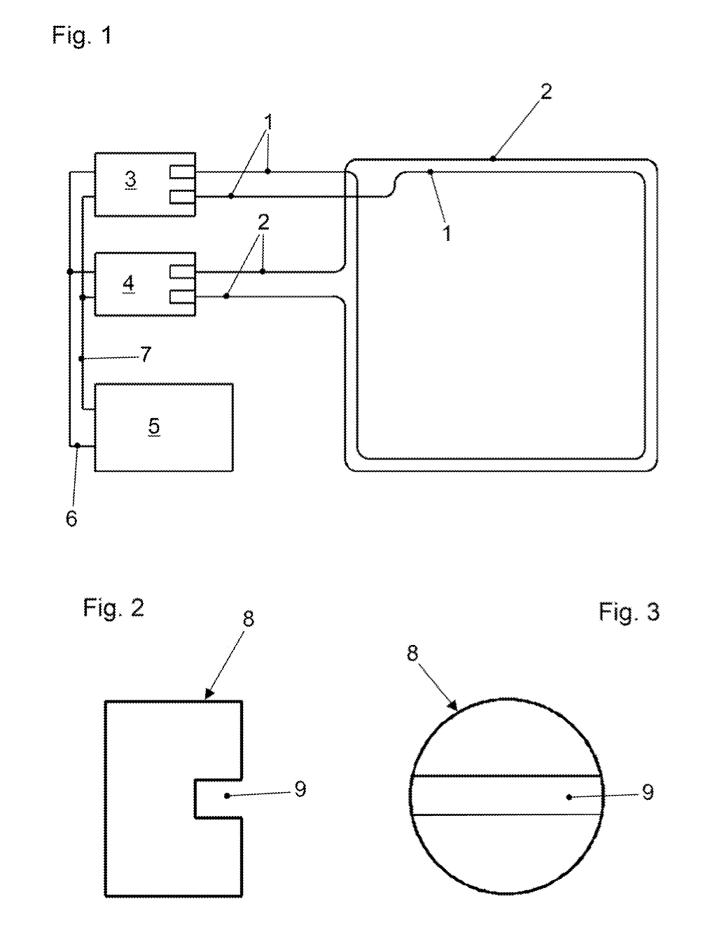

The embodiment of an apparatus according to the invention depicted in FIG. 1 includes two optical fibers 1, 2 which are arranged together in an unillustrated sensor cable. The sensor cable with the two optical fibers 1, 2 is placed in loops or in a meander or spiral shape around an unillustrated reactor, wherein the sensor cable is located as close as possible to the surface of the reactor.

It is entirely possible to provide more than two optical fibers in the sensor cable.

It is also possible to provide connecting elements such as splice boxes or connectors between partial lengths of the sensor cable.

The sensor cable may be a temperature- and/or corrosion-resistant sensor cable. For example, high-temperature optical fibers (glass fibers with a polyimide or another temperature-resistant coating) in a corrosion-resistant metal tube (stainless steel or nickel alloy) may be used. To increase the mechanical strength (particularly kink protection), the metal tube may be double-layered (tube-in-tube design) or surrounded by corrosion resistant wires.

The embodiment of the apparatus depicted in FIG. 1 further includes evaluation means with two evaluation units 3, 4, wherein one of the optical fibers 1, 2 is connected to a respective one of the evaluation units 3, 4. In each case, both ends of the respective optical fiber 1, 2 are connected to the associated evaluation unit 3, 4. In the illustrated embodiment, the two ends of the first optical fiber 1 are connected to the first evaluation unit 3 and the two ends of he second optical fiber 2 are connected to the second evaluation unit 4.

It is entirely possible to provide more than two evaluation units.

The measurement of each optical fiber 1, 2 therefore takes place from both sides (double-ended). With the evaluation units 3, 4 distributed (or quasi-distributed) measurements of physical quantities in the optical fibers 1, 2 are performed with high spatial resolution of, for example, one meter or less. The optical fibers 1, 2 may have a length of up to several kilometers. The measuring methods may include, for example, DTS (Distributed Temperature Sensing), DTSS (Distributed Temperature and Strain Sensing) or FGB (Fiber Bragg Grating).

In particular, the two evaluation units 3, 4 may evaluate the optical fibers 1, 2 independently. With this approach and also by measuring from both sides (double-ended), for example, temperature monitoring of high-temperature systems may have the advantage that the entire system can still be monitored even in the event that one of the two optical fibers 1, 2 breaks.

The embodiment of the apparatus depicted in FIG. 1 further includes control means 5, which are connected via lines 6, 7 to the evaluation units 3, 4. The lines 6, 7 can then be used to supply electrical power to the evaluation units 3, 4 and to simultaneously monitor the evaluation units 3, 4 so as to be able to respond to a failure of one of the evaluation units 3, 4. Unillustrated interfaces between the control means 5 and the evaluation units 3, 4 may also be provided.

The apparatus further includes at least one unillustrated laser light source, whose light is at least partially coupled into the optical fibers 1, 2 during the operation of the apparatus. For example, the light from the at least one laser light source may be coupled into each of the optical fibers 1, 2 from one or both sides. In particular, a separate laser light source may be provided for each of the optical fibers 1, 2.

The evaluation means may include beam splitters to separate in a conventional manner the portions of the light coupled out of the respective optical fiber 1, 2 from the light emitted by the laser light source.

The embodiment according to FIG. 2 to FIG. 5 provides magnetic retaining means 8 for attaching the sensor cable to the reactor. These have in the illustrated embodiments a substantially cylindrical shape with a radial slot 9 disposed on the side facing the surface of the reactor during the operation of the apparatus. The sensor cable may extend through this slot 9 in the longitudinal direction of the slot.

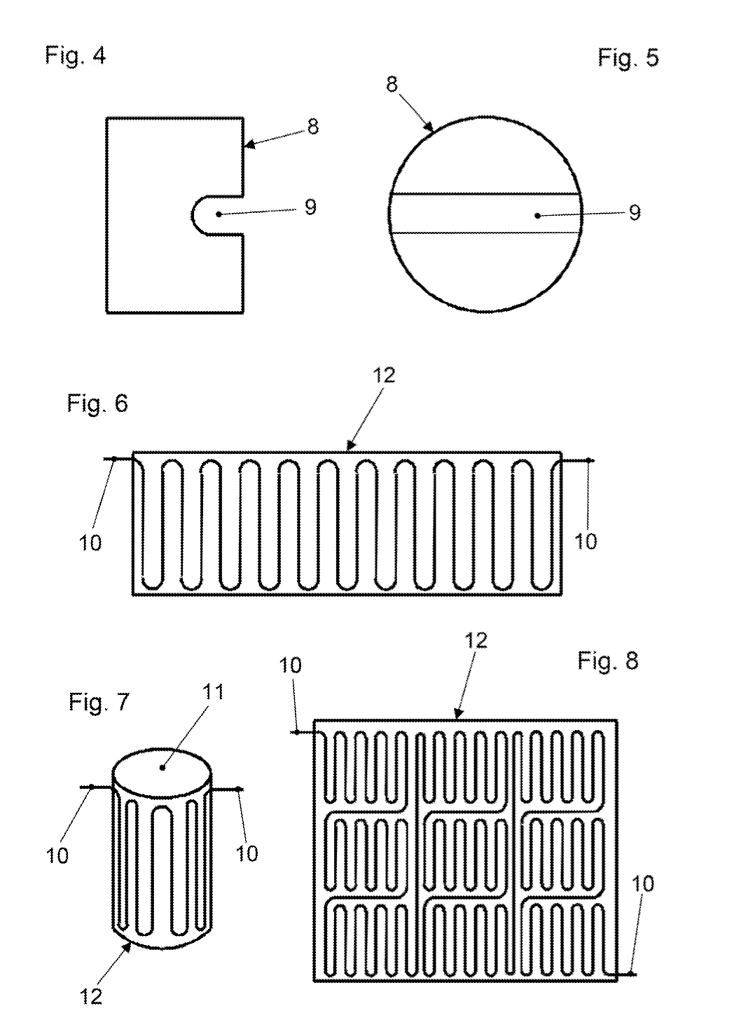

In the embodiment of FIG. 2 and FIG. 3, the inside boundary of the slot 9 is rectangular, whereas in the embodiment of FIG. 4 and FIG. 5, the inside boundary of the slot 9 is semicircular.

With the aforedescribed design of the magnetic retaining means 8, the sensor cable can be very easily attached on the reactor wall by placing the magnetic retaining means 8, while at the same time producing a good thermal contact.

The magnetic retaining means 8 may be made of a corrosion-resistant metal alloy, which remains magnetic even at high temperatures. In particular, the alloy contains cobalt and aluminum, nickel, copper, titanium, samarium and iron. For example, magnetic retaining means 8 made of AlNiCo magnets can remain magnetic to about 400° C. or SmCo magnets can remain magnetic to about 300° C. Furthermore, a corrosion-resistant coating, for example nickel or zinc, may be provided. Sintered NdFeB magnets may be employed at lower temperature requirements of, for example, maximally 200° C.

Furthermore, a consistently high holding force and a high resistance to demagnetization combined with low overall height can be achieved for the magnetic retaining means 8 with a U-shaped magnet design having a magnetic flux return plate. This unillustrated flux return plate can be made, for example, of magnetic stainless steel.

For attachment of the sensor cable 10 to the reactor 11, the embodiment of FIG. 6 to FIG. 8 provides mat-shaped or mesh-shaped retaining means 12. The retaining means 12 may preferably be designed as heat-resistant fabric or metal mats. In particular, a temperature-resistant mat or a temperature-resistant mesh may be provided. A suitable mat or a suitable mesh may include, for example, woven or linked fiberglass strands with fluorine polymer coating or a meshed wire.

In the embodiments of FIG. 6 to FIG. 8, the sensor cable 10 may be attached on the surface of the reactor 11 by cutting to size an in particular temperature-resistant mat or a mesh matching the reactor surface. The sensor cable 10 is tied in the desired installation shape onto the retaining means 12 formed, for example, as a woven fabric mat. The woven fabric mat with the inward facing sensor cable 10 is then tied around the reactor 11.

In the embodiment of FIG. 6 and FIG. 7, the sensor cable 10 is attached on or to the retaining means 12 in a meander pattern. In the embodiment of FIG. 8, the sensor cable 10 is attached in sections on or to the retaining means 12 in a meander pattern.

1. An apparatus for monitoring a reactor surface, comprising at least one sensor cable (10) which is arranged at least in sections in the region of the reactor surface during operation of the apparatus;
at least one optical fiber (1, 2) in which at least one sensor cable (10) is arranged;
at least one laser light source, whose light is at least partially coupled into the at least one optical fiber (1, 2) during operation of the apparatus;
evaluator in which portions of the light coupled out of the at least one optical fiber (1, 2) are evaluated during operation of the apparatus for monitoring at least parts of the reactor surface with respect to at least one physical variable in a spatially resolved manner;
wherein the apparatus comprises magnetic retaining means (8) for attaching the at least one sensor cable (10) on the reactor surface.

2. The apparatus according to claim 1, wherein the retaining means (8) have a slot (9) disposed on a side that faces the reactor surface during operation of the apparatus for receiving the at least one sensor cable (10).

3. The apparatus according to claim 1, wherein the device comprises at least two optical fibers (1, 2).

4. The apparatus according to claim 3, wherein the evaluator comprise at least two evaluation units (3, 4), wherein each of the evaluation units (3, 4) is connected to a corresponding one of the optical fibers (1, 2) for evaluating the light coupled out of this optical fiber (1, 2).

5. The apparatus according to claim 3, wherein the at least two optical fibers (1, 2) are arranged in the same sensor cable (10).

6. The apparatus according to claim 3, wherein each of the optical fibers (1, 2) is connected on both sides with the evaluator and/or with the at least one laser light source.

7. The apparatus according to claim 4, wherein the apparatus comprises a controller (5), wherein each of the evaluation units (3, 4) is connected to the controller (5).

8. The apparatus according to claim 1, wherein the monitored physical quantity is the temperature or the elongation of the optical fibers (1, 2).

9. The apparatus according to claim 1, wherein the apparatus comprises mat-shaped or mesh-shaped retaining means (12) for attaching the at least one sensor cable (10) on the reactor surface.

10. The apparatus according to claim 9, wherein the at least one sensor cable (10) is connected to the retaining means (12).

11. The apparatus according to claim 9, wherein the mat-shaped or mesh-shaped retaining means (12) are at least partially arranged around the reactor surface during operation of the apparatus.

12. A method for monitoring a reactor surface comprising the following steps:
providing at least one sensor cable (102) having at least two optical fibers (1, 2), the at least one sensor cable is at least in sections arranged in the region of the reactor surface;
providing laser light which is coupled into the optical fibers (1, 2);
providing portions of light coupled out of the optical fiber (1, 2) which are evaluated for monitoring at least parts of the reactor surface with respect to at least one physical quantity in a spatially resolved manner.

13. The method according to claim 12, wherein the portions of the light coupled out of the at least two optical fibers (1, 2) are evaluated independently of each other.

14. The method according to claim 13, wherein the operation of the evaluation units (3, 4) is monitored.

15. The method according to claim 13, wherein the evaluation in different evaluation units (3, 4).
